(19) United States
(12) Patent Application Publication
(10) Pub. No.: US 2019/0102749 A1
(43) Pub. Date: Apr. 4, 2019

(54) METHODS AND SYSTEMS OF RETAIL AUTOMOTIVE CHECK-IN WITH A MOBILE DEVICE

(71) Applicants: JAYAPRAKASH VIJAYAN, Dublin, CA (US); GURUSANKAR SANKARARAMAN, Dublin, CA (US); ANAND RAMAKOTTI, Dublin, CA (US); SIGMUNDO BAUTISTA, Alameda, CA (US); JUSTIN ALEXANDER CHI-YOUNG HOU, PLEASANTON, CA (US)

(72) Inventors: JAYAPRAKASH VIJAYAN, Dublin, CA (US); GURUSANKAR SANKARARAMAN, Dublin, CA (US); ANAND RAMAKOTTI, Dublin, CA (US); SIGMUNDO BAUTISTA, Alameda, CA (US); JUSTIN ALEXANDER CHI-YOUNG HOU, PLEASANTON, CA (US)

(21) Appl. No.: 15/721,569

(22) Filed: Sep. 29, 2017

(51) Int. Cl. G06Q 10/00; H04W 4/12; G06Q 30/02

(52) U.S. Cl. CPC G06Q 10/20; H04M 1/0202; G06Q 30/0283; H04W 4/12

(57) ABSTRACT

In one aspect, a computerized method implements a vehicle check-in process at an automobile dealership with a mobile device includes the step of detecting the presence of the vehicle. The method includes the step of obtaining a customer information and a vehicle information. The method includes the step of matching the, vehicle with a service consultant. The method includes the step of communicating an electronic message comprising a notification to the mobile device of the service consultant. The method includes the step of implementing a set of vehicle diagnostics to determine a set of vehicle repair actions. The method includes the step of generating an estimate of costs to service the set of vehicle repair actions. The method includes the step of communicating the set of vehicle repair actions and the estimate of the costs to service the set of vehicle repair actions to the mobile device of the service consultant in a format for rendering on a display of the mobile device.

### BACKGROUND

### 1. Field

This application relates the mobile-device applications and more specifically to a system, article of manufacture and method of retail automotive check-in with a mobile device.

### 2. Related Art

Currently, the automotive retail check-in experience is quite antiquated. Many companies use paper and pencil to collect information and then record it into a dealer management system. Other companies use a Web experience where tablet computers access websites to allow a portable, but not truly mobile, experience. Tablet computers may not offer the same mobility, portability, and/or pocketability that mobile devices like wearables and smartphones offer. For example, the smartphone's form factor and user familiarity with the device's form factor (e.g., many people have and use smart phones) can help to ensure service consultants are always connected with their service lane while reducing the training required for new users.

### SUMMARY

In one aspect, a computerized method useful for implementing a vehicle check-in process at an automobile dealership using a mobile device includes the step of detecting the presence of the vehicle. The method includes the step of obtaining a customer information and a vehicle information. The method includes the step of matching the vehicle with a service consultant. The method includes the step of communicating an electronic message comprising, a notifications to, the mobile device of the service consultant. The method includes the step of implementing a set of vehicle diagnostics to determine a set of vehicle repair actions. The method includes the step of generating an estimate of costs to service the set of vehicle repair actions The method includes the step of communicating the set of vehicle repair actions and the estimate of the costs to the mobile device of the service consultant in a format for rendering on a display of the mobile device. The method can include a customized workflow combining a merger of information from an automobile dealership database, an OEM, database and the like.

### BRIEF DESCRIPTION OF THE DRAWINGS

FIG. 1 illustrates an example system for retail automotive check-in with a mobile device, according to some embodiments.

FIG. 2 depicts an exemplary computing system that can be configured to perform any one of the processes provided herein.

FIG. 3 is a block diagram of a sample-computing environment that can be utilized to implement various embodiments.

FIGS. 4A-B illustrate an example process 400 for implementing automobile mobile-device check-in process according to some embodiments.

FIGS. 5 illustrates an example vehicle and customer identification process, according to some embodiments.

FIGS. 6-15 illustrate a set of illustrative screen shots for implementing some embodiments provided herein.

The Figures described above are, a representative set, and are not an exhaustive with respect to embodying the invention.

### DESCRIPTION

Disclosed are a system, method, and article of manufacture of retail automotive check-in with a mobile device. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment of the present invention. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or>more embodiments, in the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein, are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate awaiting or monitoring period of unspecified duration between enumerated steps of the depicted method. Additionally, the order in which a particular method occurs may or may not strictly adhere to the order of the corresponding steps shown.

### EXAMPLE DEFINITIONS

Application can be a computer program designed to perform a group of coordinated functions, tasks and/or activities for the, benefit of the user.

Automotive Retail Check-in can be the process in which customers are processed for a visit to an Automotive Retail store (e.g. an automobile dealership, an automobile independent service provider, an automobile auto body shop, an automobile tire store, etc.).

BLUETOOTH® Low Energy (BLE) can be a wireless personal area network technology. BLE can increase in data broadcasting capacity of a device by increasing the advertising data length of low energy BLUETOOTH® transmissions. A mesh specification can enable using BLE for many-to-many device communications for home automation, sensor networks and other applications.

Low-Power Wide-Area Network (LPWAN) and/or Low-Power Network (LPN) is a type of wireless telecommunication wide area network configured to allow long range communications at a low bit rate among connected objects, such as, sensors operated on a battery. The low power, low bit rate and intended use distinguish this type of network from a wireless WAN that is designed to connect users or businesses, and carry more data, and thus, using more power. LoRa can be a chirp spread spectrum (CSS) radio modulation technology for LPWAN. It is noted that various other LPWAN networks can be utilized in various embodiments in lieu of a LoRa network and/or system.

Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alfa: decision tree learning, association rule learning, artificial neural networks, inductive logic programming, support vector machines, clustering, Bayesian networks, reinforcement learning, representation learning, similarity and metric learning, and/or sparse dictionary learning.

Mobile device can be a handheld computer such as art phone.

On-board diagnostics (OBD) can, be a system that leverages a vehicle's self-diagnostic and reporting capability. OBD systems can provide the vehicle owner, repair technician and the like, access to the status of the various vehicle subsystems. For example, if the customer is a returning customer, the OBD can be used to automatically pull up ail the customer information and service history upon plugging in the OBD device and obtaining the vehicle identification number (VIN).

Pairing can be the linking together of devices o allow communications between them.

Radio-frequency identification (RFID) can use electromagnetic fields to automatically identify and track tags attached to objects. The tags can contain electronically stored information, Passive tags collect energy from a nearby RFID reader's interrogating radio waves. Active tags can have a local power source, such as, a battery, and may operate at hundreds of meters from the RFID reader/scanner.

Three-dimensional representation (3D) can include 3D computer graphics. 3D computer graphics can use a three-dimensional representation of geometric data and render said data on a user interface such as a mobile-device display.

3D rendering can be the 3D computer graphics process of automatically converting 3D wire frame models into two-dimensional representation (2D) images with 3D photorealistic effects or non-photorealistic rendering on a computer.

### Exemplary Systems and Computer Architecture

A mobile-device implemented vehicle check-in process is provided. The vehicle check-in process enables a consistent and configurable experience for automobile dealership service consultants to process vehicles coming in for service. The vehicle check-in process can be used by a number of persons (e.g. a sales consultant, service advisor, service consultant, greeters, etc.). The vehicle check-in process can integrate with an RFID/Tag Reader to provide a service consultant with instant-notifications that a customer has arrived with a vehicle for service. The vehicle check-in process can implement automated data entry of the customer information and/or the vehicle information (e.g. using driver's license or credit card information to collect address, name, driver's license number, etc.). In one example, the name of the customer can be obtained along with the other information that resides in a driver's license. The application can, upon reading the scanned driver's license: pull up the customer information in the automobile dealer's system, and auto-populate customer information and vehicle information in the service mobile application.

A check-in application can be implemented in the mobile device of the service consultant. The check-in application can enable a single experience where customers are personally making the decisions in the presence of the service consultant. The check-in application can be used by the customer to, inter alis; verify key information (e.g. personally identifiable information), perform a digital inspection of the vehicle, sign the estimate and agreement to work, read and verify a disclaimer, view and then select/add recommendations to a digital cart, etc.

Customers can be given the mobile device with the application and review vehicle repair, parts, warranty and/or other recommendations. Additionally, customers can use the check-in application to select said options and verify the information. The check-in application can be used for customer communication. The service consultant can upload pertinent information to a customer via a text, email, or print-out directly on the mobile device. The service consultant can share such information as, inter alis: quick estimates (e.g. to provide customers with a breakdown of the cost of a set of services), available service menus (e.g. to provide a detailed breakdown of a specific type of service), future maintenance schedules (e.g. to provide a forward-looking view of upcoming, service the vehicle should receive), etc. The service consultant can also communicate completed estimates (e.g. a copy of the agreed terms and disclaimers with areas of compliance covered) to the customer..

It is noted that, as used herein, other automobile service providers (e.g. an automobile independent service provider, an automobile auto body shop, an automobile tire store, and the like) can be utilized in lieu of an automobile dealership in other example embodiments.

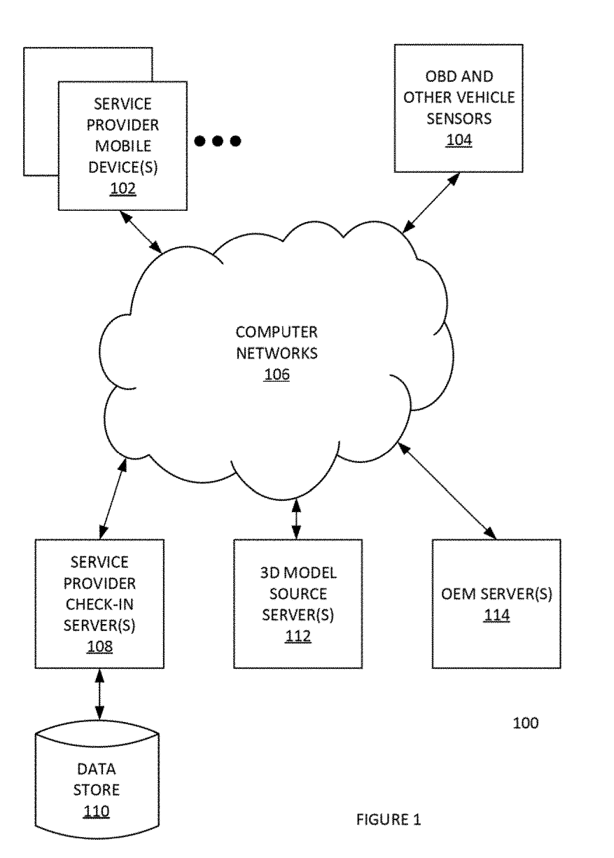

FIG. 1 illustrates n example system 100 for retail automotive check-in with a mobile device, according to some embodiments. FIG. 1 illustrates an example system 100 for three-dimensional model data capturing and retrieving for automotive inspection, service and maintenance, according to some embodiments. System 100 can include various computer and/or cellular data networks 100. Networks 106 can in dude the Internet local area networks (LAN) 104, enterprise wide networks, text messaging networks (e.g. short messaging, service (SMS) networks, multimedia messaging service (MMS) networks, proprietary messaging networks, instant messaging service networks, email systems, etc., Networks 106 can be used to communicate messages and/or other information from the various entities of system 100. Networks can also include LPWAN, BLE and/or various local area networks.

In one example embodiment, system 100 can include service provider mobile device(s) 102. Service provider mobile device(s) 102 can be a smart phone, etc. Service provider mobile device(s) 102 can include a check-in application that implements the service-provider functions of the processes provided herein. The check-in application can be used to obtain vehicle information via user input, OBD 104 input, other vehicle sensor(s) input, digital inspection, etc.

OBD 104 can pull vehicle information (e.g. vehicle model vehicle make, vehicle year, etc.). An employee of the automobile dealership, can insert OBD 104 after the vehicle enters a service lane.

The service consultant and customer can perform a digital inspection of the vehicle. The digital inspection can be used to identify vehicle damage. The digital inspection can use a 3D vehicle model obtained from the vehicle manufacturer. The,digital inspection can input/tag rich media (photo, video, audio, depth sensors, vehicle diagnostic data from the OBO device, etc.) into the 3D vehicle model. The 3D vehicle model can be configured to allow damage data to be collected and tagged to a particular location/part of the 3D vehicle mode The 3D vehicle model (and/or the rich media) can be displayed on the service-consultant's mobile device. Vehicle information can be combined with damage data determined during the digital inspection. This can be used to generate a list of recommended services and parts.

Repair estimates can be automatically generated by service provider check-in server(s) 108. Service provider check-in server(s) 108 can log vehicle information, damage inspection data, etc. for various analytics.

It is noted that various machine learning methods can be implemented to improve analytical methods. For example, service provider check-in server(s) 108 can aggregate data from multiple customers for later analysis in order to improve the check-in process. Further, machine learning can be used to develop targeted recommendations for accessories parts, services, etc. The vehicle check-in process can leverage Web and cloud-connected platforms to provide real-time (e.g. assuming network and/or processing latencies), customized data for sales opportunities and targeted advertising for customers and vehicles.

Service provider check-inservers) 108 can pull vehicle information and information from a local Dealer Management System. This information can then be combined with data from an OEM entity to provide a consolidated view insurance information can be pulled from insurance companies based on, inter alia, vehicle VIN, or policy number. Additionally, new policies, extended warranties, and service contracts, can also be captured via camera and the image can be recognized with optical character recognition methods so that the data and information can be auto-populated, stored and retrieved in the future. Insurance policy information can be used for rental and loan agreements.

Service provider check-in server(s) 108 can generate customizable workflows between dealerships, customers, and manufacturers (e.g. OEMs). Manufactures provide dealerships processes for specific brand requirements. Dealerships provide customizations to improve sales of services and accessories. Service provider check-in server(s) 108 can generate automotive retail mobile check-in that can be configured remotely by a service consultant, manufacturers/OEMs and dealerships for implementing collaboratively customizable check-in flows.

Returning to the check-in process, the check-in application can be used to select repairs and/or vehicle parts for service. For example, the check-in application can display the 3D model of a vehicle representing the customer's vehicle. The check-in application can enable users to tag various vehicle state information (e.g. repair information, damage information, vehicle parts information, etc.) onto a display of the 3D model. The 3D model can be interacted with by a user (e.g. via touchscreen gestures, text input, etc.). In this way, rich data generated herein can be tagged to annotate information on the 3D model for inspection and damage. The 3D model can be displayed as an image with 3D effects on the service provider mobile device(s) 102. The 30 model can be rendered from a vehicle manufacture's computer-aided design (AD) design(s) to produce replicas of the model for the service and maintenance experience.

Various functionalities described herein can be offloaded to service provider check-in server(s) 108. Service provider check-in server(s) 108 can implement, inter alia: gesture recognition; 3D rendering; database management; calls to third party servers for vehicle type data/parts ordering/manufacturer notification; annotation actions (via data tags, etc.); etc. Service provider check-in server(s) It can be implemented in a cloud-computing platform and/or on an on-premises server.

Service provider check-in server(s) 108 can obtain original 30 models of a vehicle type from 3D model source server(s) 112. As noted above, these 3D models can allow a user to interactively collect data and associate it in a displayed replica model of the vehicle. Example uses of 3D model data can include, inter alia: damage review, inspection, ordering replacement parts, etc. Service provider check-in server(s) 108 can use vision recognition and object detection to provide suggestions for parts to be ordered/used and/or visual identification for repair technicians to improve communication between the service consultant and the technician. 3D model data can enable display and review of detailed information about concerns/issues to be sent to vehicle manufacturers and OEMs to better understand issues from customers.

Data obtained by system 100 can be communicated to various other entities such as, inter alia: OEM servers 114, vehicle manufacturers, analytics entities, etc. Data can be stored in data store 110. Data store 110 can include customer information, historical information, service consultant current state/expertise, etc.

Third-party data, such as customer review websites, can be added to improve trust (e.g. other customers also purchased, government agency data, third party data, customer reviews and ratings, price comparisons from other sites and retailers).

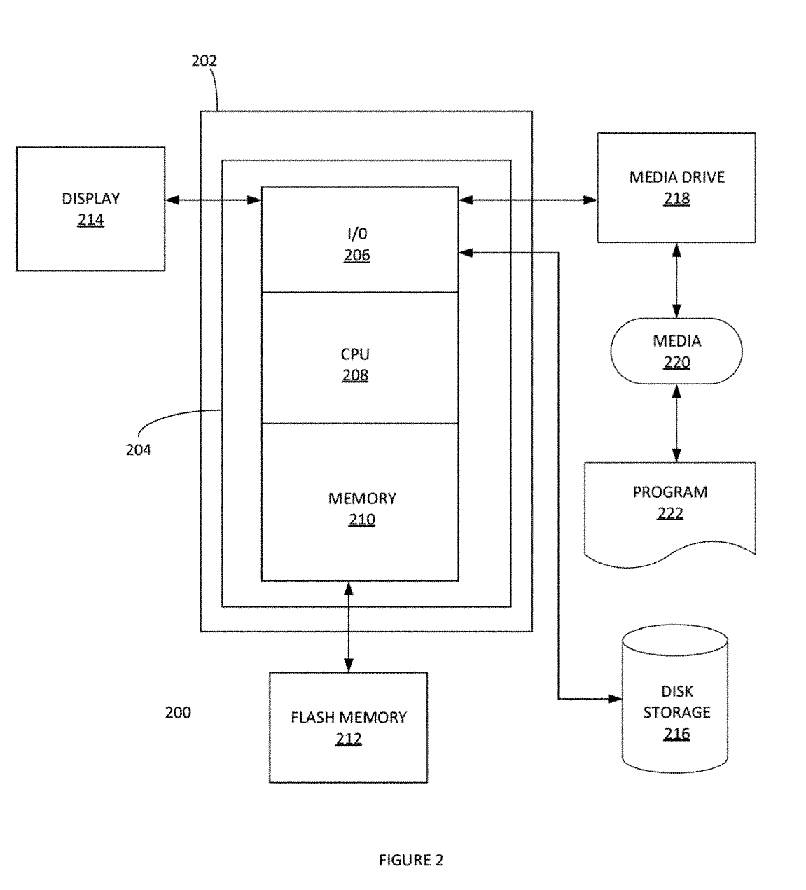

FIG. 2 depicts an exemplary computing system 200 that can be configured to perform any one of the processes provided herein. In this context, computing system 200 may include, for example, a processor, memory, storage, and I/O device (e.g., monitor, keyboard, disk drive, Internet connection, etc.). However, computing system 200 may include circuitry or other specialized hardware for carrying out some or all aspects of the processes. In some operational settings, computing system 200 may be configured as a system that includes one or more units, each of which is configured to carry out some aspects of the processes either in software, hardware, or some combination thereof.

FIG. 2 depicts computing system 200 with a number of components that may be used to perform any of the processes described herein. The main system 202 includes a motherboard 204 having an I/O section 206, one or more central processing units (CPU) 208, and a memory section 210, which may have a flash memory card 212 related to it. The I/O section 206 can be connected to a display 214, a keyboard and/or other user input (not shown), a disk storage unit 216, and a media drive unit 218. The media drive unit 218 can read/write a computer-readable medium 220, which can contain programs 222 and/or data. Computing stem 200 can include a web browser. Moreover, it is noted that computing system 200 can be configured to include additional systems in order to fulfill various functionalities. Computing system 200 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

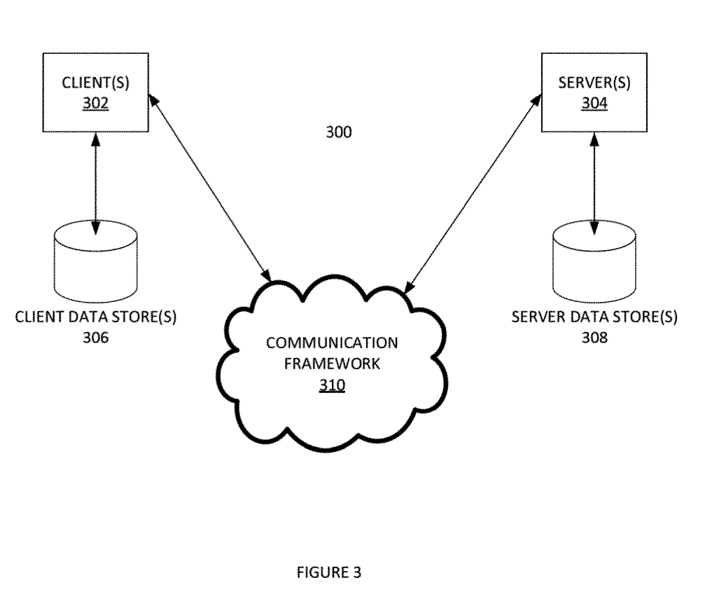

FIG. 3 is a block diagram of a sample-computing environment 300 that can be utilized to implement various embodiments. The system 300 further illustrates a system that includes one or more client(s) 302. The client(s) 302 can be hardware and/or software (e.g., threads, processes, computing devices). The system 300 also includes one or more server(s) 304. The server(s) 304 can also be hardware and/or software (e.g., threads, processes, computing devices). One possible communication between a client 302 and a server 304 may be in the form of a data packet adapted to be transmitted between two or more computer processes. The system 300 includes a communication framework 310 that can be employed to facilitate communications between the client(s) 302 and the server(s) 304. The client(s) 302 are connected to one or more client data store(s) 306 that can be employed to store information local to the client(s) 302. Similarly, the server(s) 304 are connected to one or more server data store(s) 308 that can be employed to store information local to the server(s) 304. In some embodiments, system 300 can instead be a collection of remote computing services constituting, a cloud-computing platform. It is noted that various functionalities of systems 100-300 can be implemented as virtual systems and/or in a cloud-computing platform, according to some embodiments.

Exemplary Methods

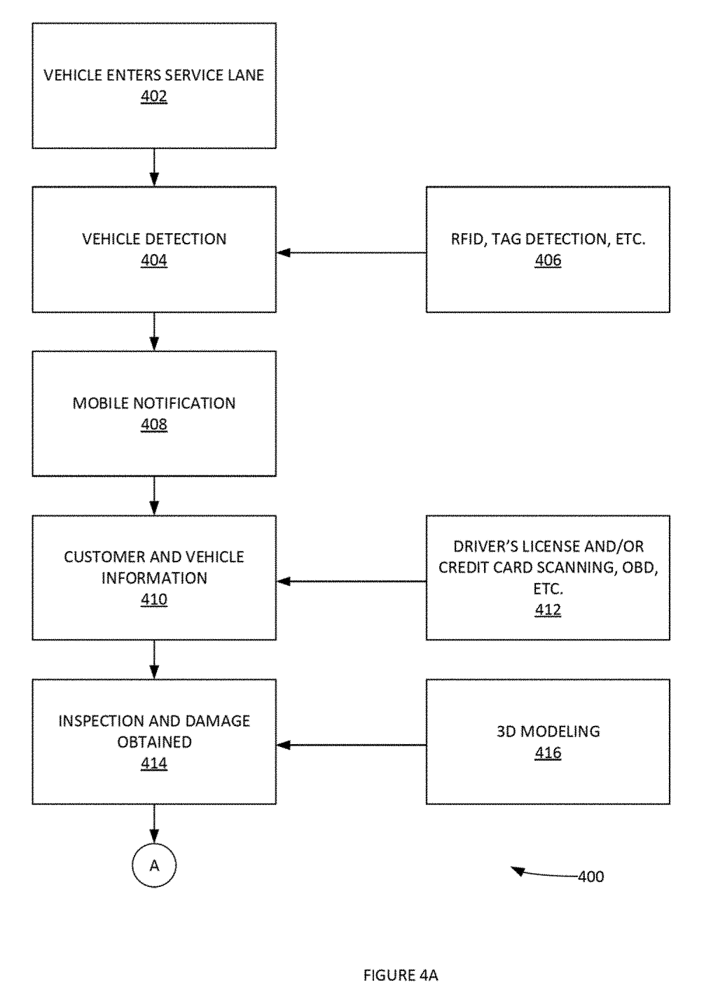

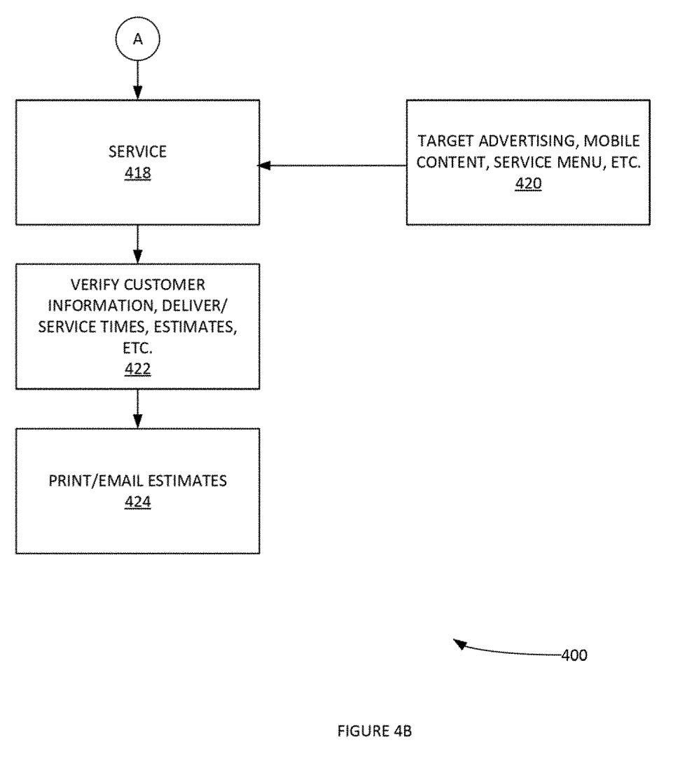

FIGS. 4A-B illustrate an example process 400 for implementing an automobile mobile-device check-in process, according to some embodiments. An step 402, process 400 can a customer's vehicle enters the service lane of an automobile dealership. In step 404, process 400 can automatically detect the presence of the vehicle. Various methods 406 of vehicle detection can be implemented, including, inter alia: RFID systems, RAD tag detection systems, etc.

In step 408, process 400 can communicate an electronic message containing a notification to the mobile device of a service consultant. For example, process 400 can automatically match the customer/vehicle with a service consultant (e.g., based on a service consultant availability, etc.). In one example, process 400 can match the service advisor to the customer based on both service advisor availability and prior service history.

In step 410, process 400 can obtain customer and vehicle information. For example, customer information can be obtained from driver's license and/or credit card data 412 obtained by a scanning operation. Step 410 can include vehicle information (e.g., make/model/year) obtained from an OBD device coupled to the vehicle by a service consultant and/or other employee. In step 414, process 400 can implement various inspection operations and vehicle repair needs/damage can be obtained. For example, step 414 can include the digital inspection of the vehicle to identify a damage type discussed above. The digital inspection can use the 3D model provided by step 416.

In step 416, process 400 can implement 3D rendering of a 3D model of the vehicle. A 3D model for automotive inspection, service and maintenance can be a 3D rendering of a vehicle that are similar or match the make/model/year of the customer's vehicle. The 3D model can be displayed on a user interface (e.g., a mobile-device touch screen, a laptop touch screen, etc.). The 3D model can be interacted with by a user. Touchscreen gestures (e.g. multitouch, gesture-enhanced single-touch, single touch, stylus input patterns, virtual buttons, virtual keypad input, etc.) can enable predefined motions to provide input into a computing device and software. Various 3D rendering visual inspection functions an be triggered by specified multi-touch gestures. For example, a user can provide gesture/touch input to spin the 3D model of the vehicle. The user can provide gesture/touch input to zoom in on a display of the 3D model of the vehicle (e.g. a pinching gesture can cause the 3D model of the vehicle to zoom). The user can provide gesture/touch input to rotate in on a display of the 3D model. The user can provide gesture/touch input to add or remove annotations on the 3D rendering of the vehicle. The annotations can include damage type of a vehicle portion or part,

In step 418, process 400 can verify customer information, deliver/service times, estimates, etc. In step 420 process 400 can print/email estimates. For example, the service advisor can print the services and the estimate of cost for those services directly from the mobile device using Wi-Fi or Bluetooth technology. It is noted that other electronic messages (e.g. text messages, instant messages, bot chats, etc.) can be utilized in step 420. In step 422, the automobile dealership can perform the service/repairs identified in the previous steps of process 400. In step 424, target advertising, mobile content, service menu, etc. can be provided to the customer during the service/repairs.

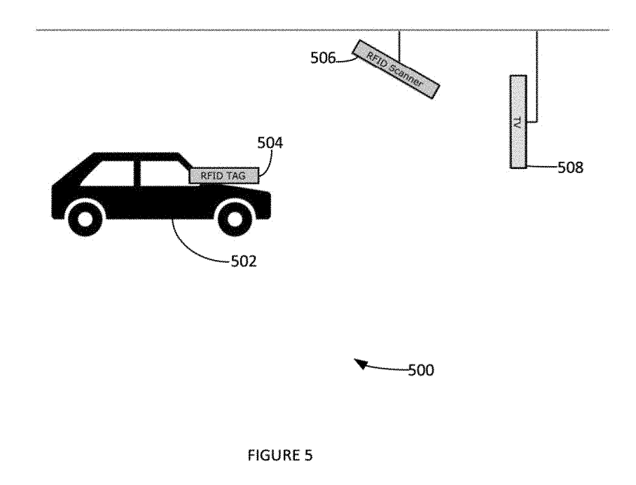

FIG. 5 illustrates an example vehicle and customer identification process 500, according to some embodiments Vehicle and customer identification process 500 can use an integrated RFID/tag 504 and scanner 506. Process 500 uses RFID tag reading to identify a vehicle as the vehicle is driving into a particular area of the automobile dealership. A tag can be attached in vehicle 502 and a scanner 506 is installed in a particular area of a dealership. If the scanner 506 is assigned a location, for example a service lane, then process 500 can communicate a notification to the check-in application of the service consultant. The notification can communicate that a vehicle has arrived or moved to a particular location. In an example of automotive retail check-in, the RFID scanner 506 can detect RFID tag 504 on vehicle 502 and communicate a message that the customer is at the location to the various potential service consultants who can then assist the customer. Based on the customer's arrival in the service lane or check-in area, the service consultant can directly click on the message to view information about the customer, the vehicle, etc. This data can be combined with other check-in application data. In this way, the service consultant can determine, in real time, which vehicles and/or customer are waiting for service and in what location.

### Example Application Screen Shots

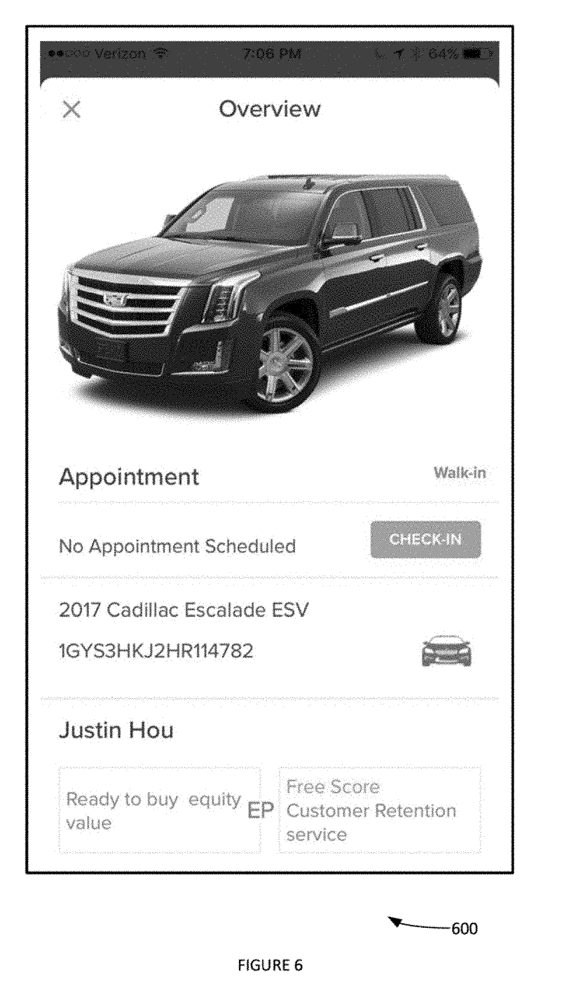

FIG. 6 illustrates the first screen shot of a check-in work flow for display on a service consultant's mobile device, according to some embodiments. The screen shot can display information about the customer's appointment (e.g. customer information, appointment information, vehicle information, etc.).

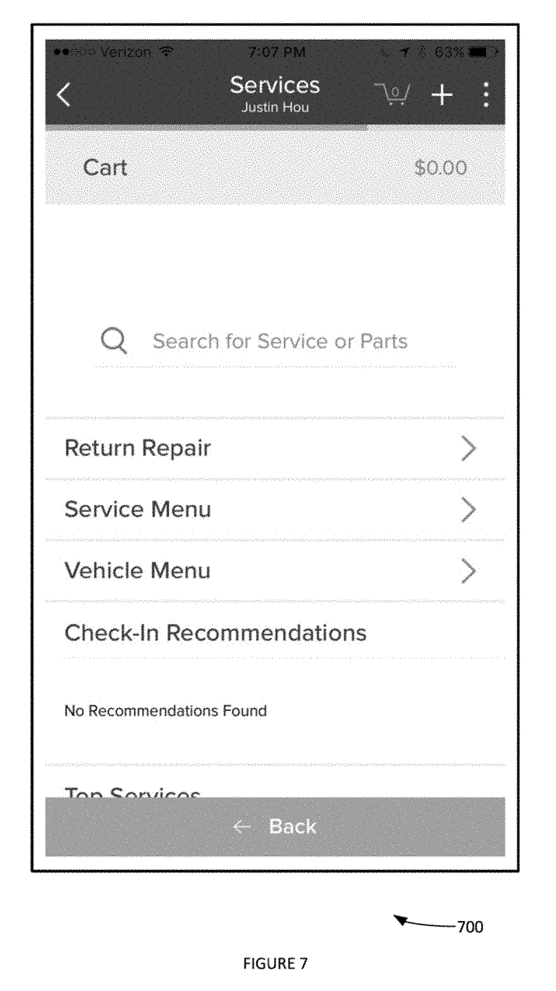

FIG. 7 illustrates a screen shot of vehicle-repair appointment information, according to some embodiments. Various information about the appointment can be displayed (e.g. customer information, appointment information, vehicle information, etc.).

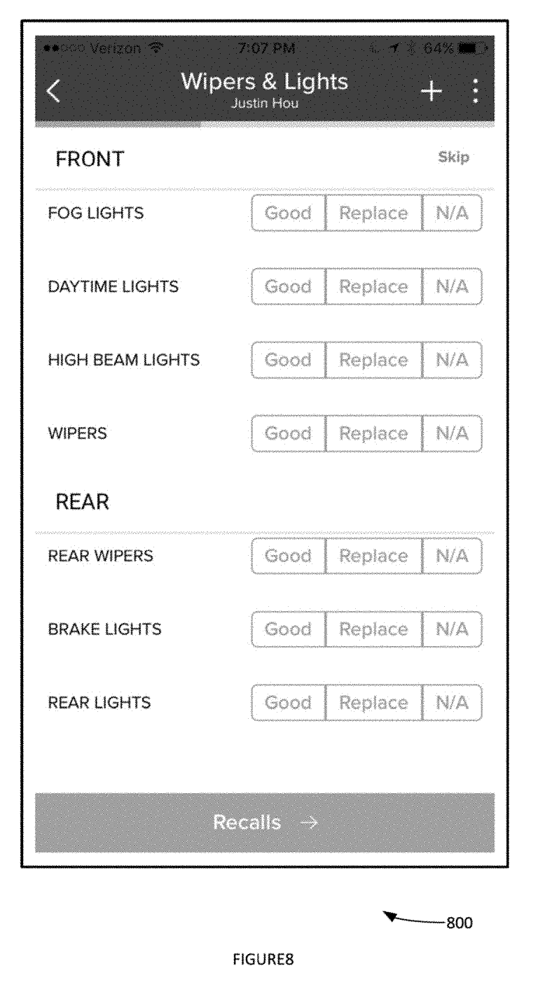

FIG. 8 illustrates a screen shot for service consultant input, according to some embodiments. The service consultant can perform a safety inspection then input various information about the inspection (e.g. vehicle lights information, windshield wiper information, tire information, etc.). Replacement parts can be ordered by inputting order requests directly from the screen.

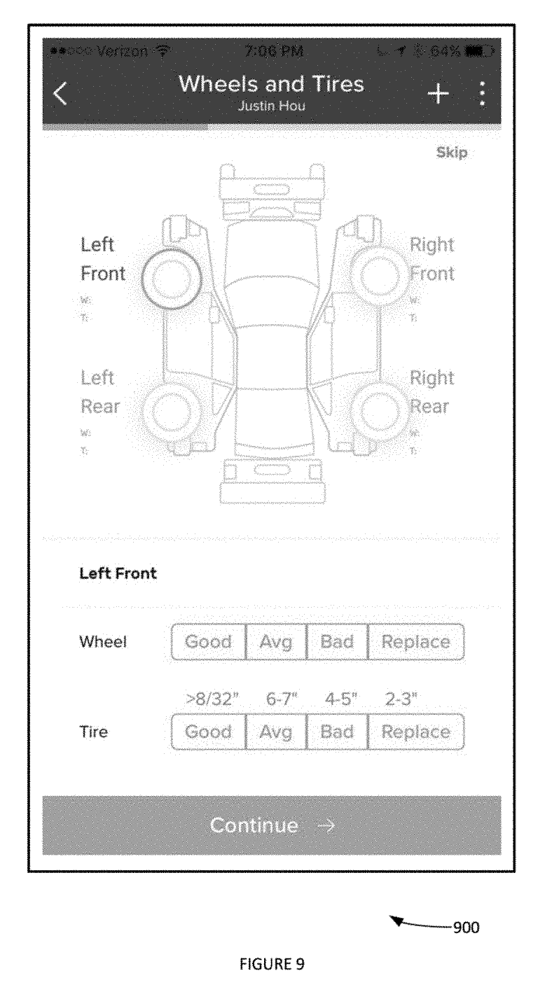

FIG. 9 illustrates an example of a screen shot for service consultant input, according to some embodiments. Service consultants can check all tires and wheels of the customer's vehicle. Service consultants can input information about the tires and/or wheels into the touchscreen of a mobile device. Service consultants can input a text description information as well. This data can be tracked and various analytics can be implemented accordingly. For example, this information can be used to determine if a service provider isn't correctly performing tire/wheel inspections. This information can be used by third-party tire/wheel parts providers to update logistics such as parts ordering, design improvement, etc. It is noted that other vehicle schematics and/or screens can be used to obtain input for other vehicle systems.

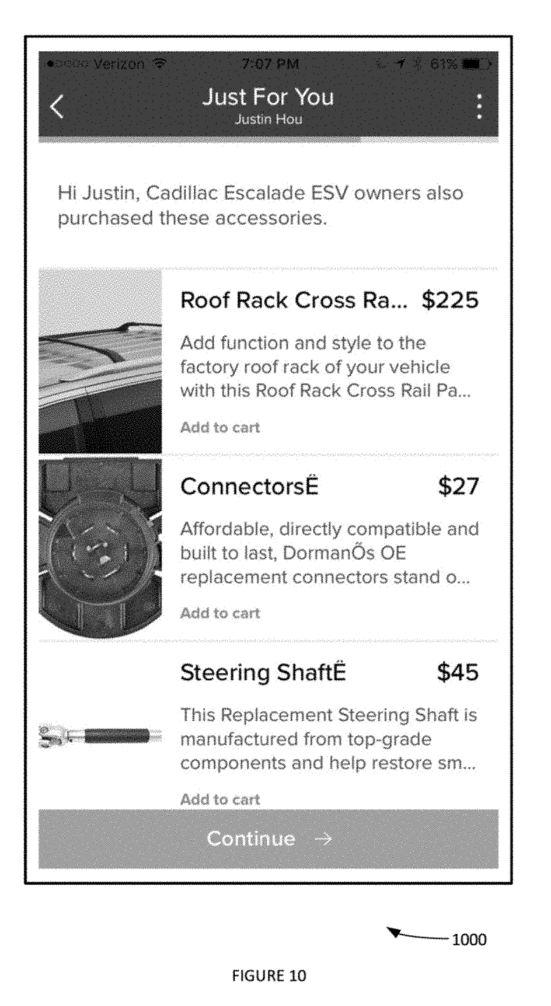

FIG. 10 illustrates an example screen shot of up-sale opportunities that are generated from information obtained during the check-in process, according to some embodiments. The mobile device can be handed to the customer to indicate which, if any, of the up-sale items to include in the vehicle's service.

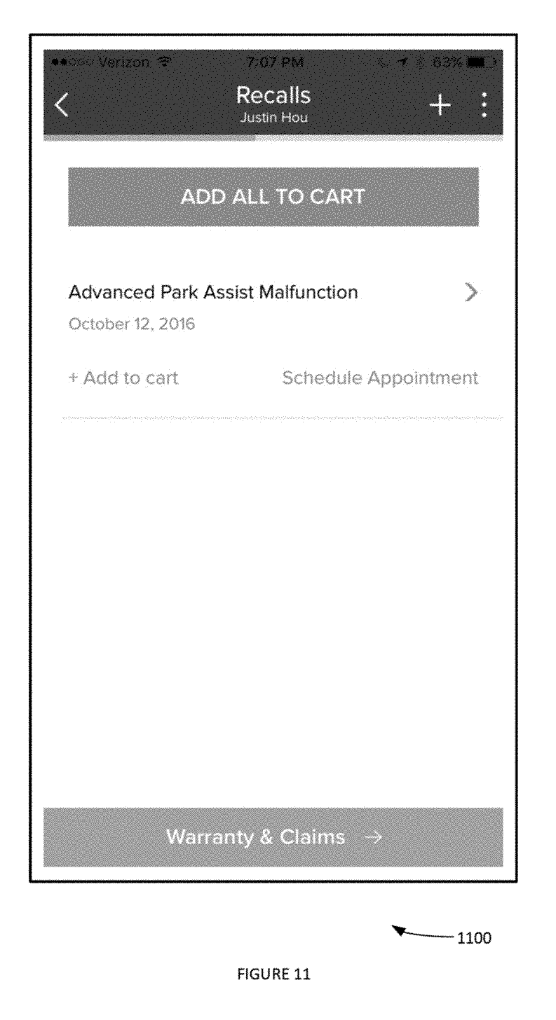

FIG. 11 illustrates an example screen shot of recalls relating to the vehicle, according to some embodiments. The recalls can be determined and displayed based on the make/model/year of the vehicle. The service consultant and/or customer can provide input to select recall items/repairs. A separate appointment can be scheduled accordingly to handle these services.

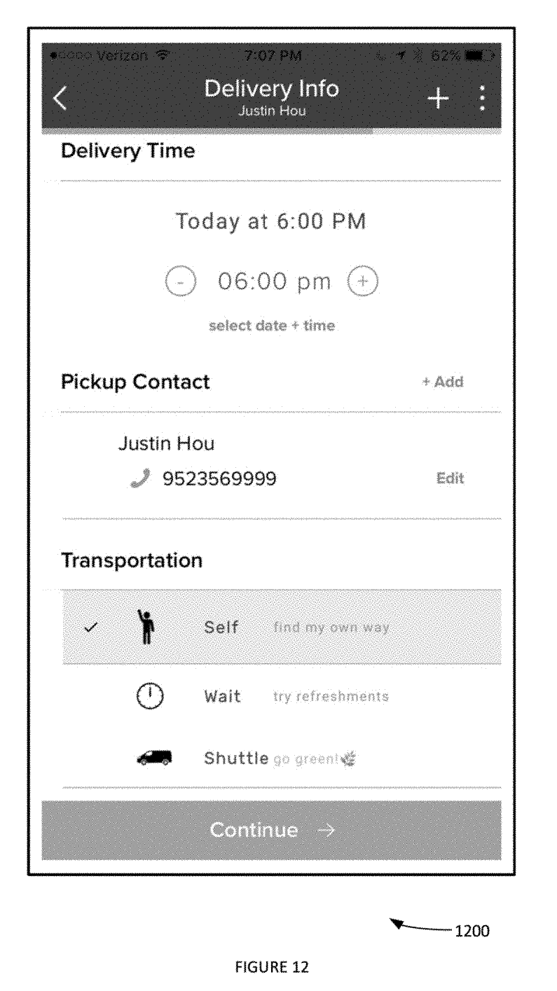

FIG. 12 illustrates an example screen shot of a mobile-device display used to collect various customer data during a check-in process, according, to some embodiments. For example, data about, inter alia; delivery time, pick up contacts and transportation for appointment booking, etc. can be obtained. This information can be electronically communicated to the user as well (e.g. via reminders, etc.). This information can be used when another person other than the customer is picking up the vehicle at a later time such that the automobile dealership is able to verify this person has permission to obtain the vehicle.

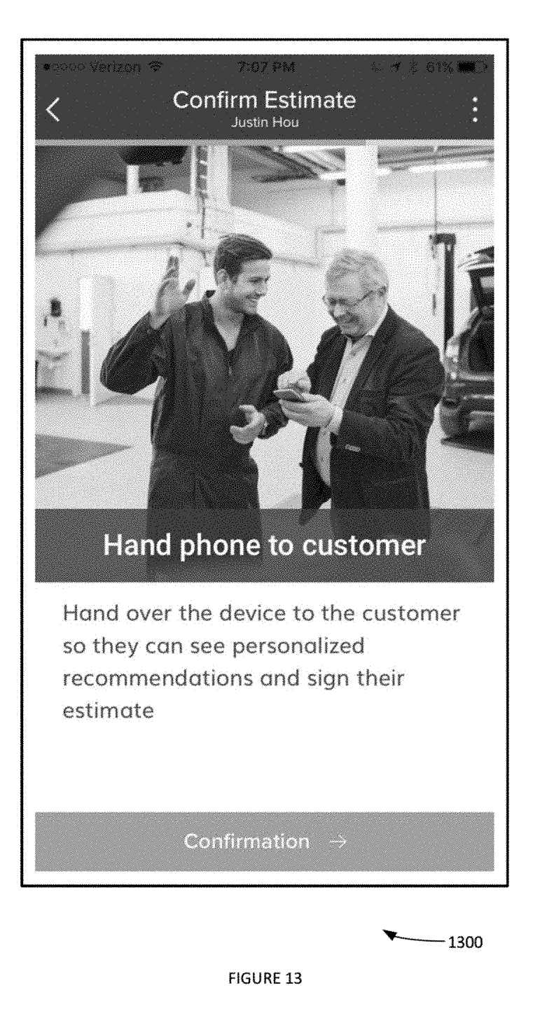

FIG. 13 illustrates a screen shot indicating that the mobile device should be handed to the customer for customer input, according to some embodiments.

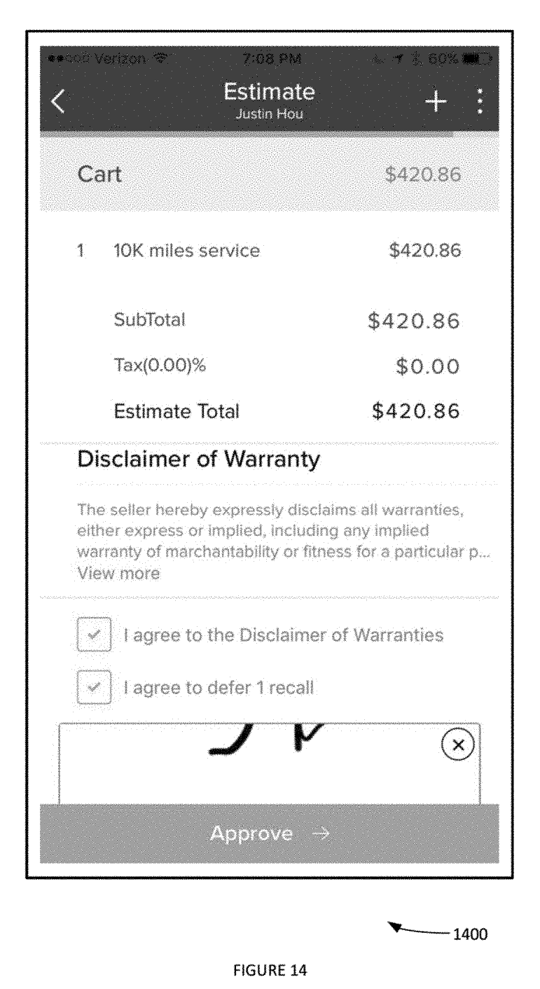

FIG. 14 illustrates a screen shot of a mobile-device display used to collect a customer's signature, according to some embodiments. The mobile-device display can also include repair/service cost estimates.

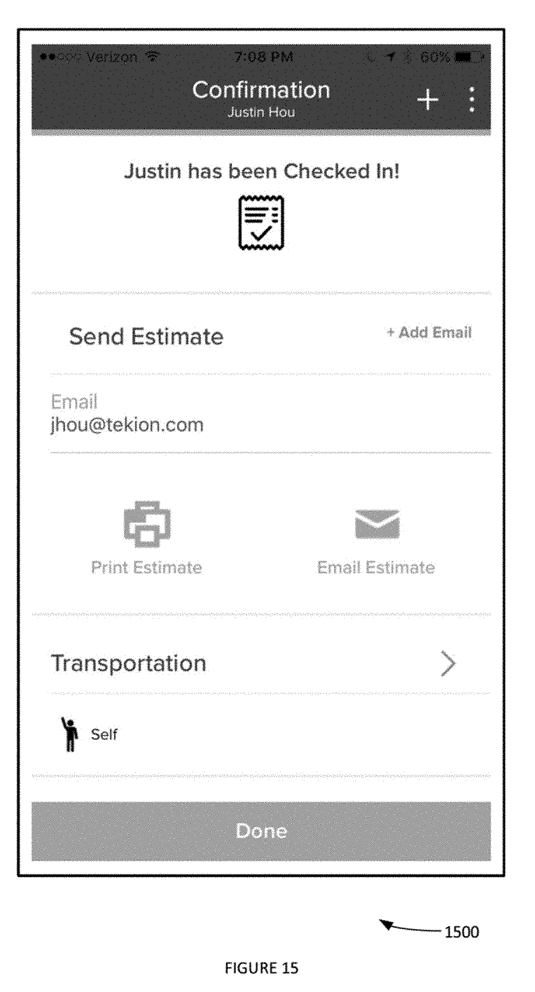

FIG. 15 illustrates a screen shot of a mobile-device display used to sign off a customer check-in experience, according to some embodiments. Emails can be sent to the customer and other relevant parties.

It is noted that these screen shots are provided by way of illustration and other embodiments can include other specific information relevant to other repair/service operations. Additionally, other permutations/sequences of the screen shots can be used in various example embodiments.

In some examples, the service consultant can, also share the recommended services based on mileage (e.g. a twenty-five thousand (25K) mileage service) by swiping the screen from his/her mobile device to display on a customer facing device (e.g. iPad or TV screen or monitor. Additionally, a machine learning model can recommend certain products for purchase by the customer based on, inter alia;l purchasing patterns of other customers owning similar vehicles, and the result of inspection of that specific vehicle.

In one example embodiment, a post-check in process can inform the customer of the exact status and location of the customer's vehicle in the service process through notifications on, a television screen in the waiting lounge. The customer can be informed via the television screen when service is complete and the vehicle is ready for pick up.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it will be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to protected by Letters Patent United State:

1. A computerized method useful for implementing a vehicle check-in process at an automobile dealership with a mobile device comprising:
detecting the presence of the vehicle in a service lane of the automobile dealership;
obtaining a customer information;
obtaining a vehicle information;
matching the vehicle with a service consultant;
communicating an electronic message comprising a notification to the mobile device of the service consultant notifying the service consultant that the vehicle is n the service lane;
obtaining a vehicle's diagnostic information;
interpreting the vehicles diagnostic information to recommend a set of vehicle repair actions;
generating an estimate of the costs to service the set vehicle repair actions; and
communicating the set of vehicle repair actions and the estimate of the costs to service the set of vehicle repair actions to the mobile device of the service consultant in a format for rendering on a display of the mobile device.

2. The computerized method of claim 1 wherein the step of detecting the presence of the vehicle further comprises:
with a Radio Frequency Identifier (RFID) scanner n the service lane of the auto mobile dealership, detecting an RFID tag in the vehicle v hen the vehicle enters the service lane of the automobile dealership.

3. The computerized method of claim 1, wherein the step of obtaining a vehicle information further comprises:
communicatively coupling the vehicle with an Onboard Diagnostic (OBD) device, wherein the OBD device is connected to the vehicle by an employee of the automobile dealership; and
obtaining the vehicle information from the OBD device.

4. The computerized method of claim 1, wherein the service consultant is matched with the vehicle based on based on a service-consultant availability.

5. The computerized method of claim 1,
wherein the customer information comprises a vehicle-owner name obtained from a scan of a vehicle-owner's driver's license, and
wherein the vehicle information comprises a vehicle make, a vehicle model, and a vehicle year and a service history.

6. The computerized method of claim 1 further comprising:
obtaining a manufacturer's three-dimensional vehicle model that matches the vehicle information.

7. The computerized method of claim 6, wherein the step of obtaining the vehicle's diagnostic information further comprises
performing a digital inspection of the vehicle to identify a damage type;
displaying a mocks-up of the manufacturer three-dimensional vehicle model; and
configuring the display of the manufacture three-dimensional vehicle model to associate the damage type with a relevant,part of the manufacturer's three-dimensional vehicle model and marking the three-dimensional model with the damage type.

8. A computer system useful for implementing a vehicle check-in process at an automobile dealership with e mobile device comprising:
a processor;
a memory containing instructions when executed on the processor, causes the processor to perform operations that:
detect the presence of the vehicle in a service lane of the automobile dealership;
obtain a customer information;
obtain a vehicle information;
match the vehicle with a service consultant:
communicate an electronic message comprising a notification to the mobile device of the service consultant notifying the service consultant that the vehicle is in the service lane;
implement et of vehicle diagnostics to determine a set of vehicle repair actions;
generate an estimate of the costs to service the of vehicle repair actions;
communicate the set of vehicle repair actions and the estimate of the costs to the mobile device of the service consultant in a format for rendering on a display of the mobile device,

9. The computerized system of claim 8, wherein the memory containing instructions when executed on the processor, causes the processor to perform operations that:
detect, with Radio Frequency identifier (RFID) scanner, an RFID tag in the vehicle when the vehicle enters the service lane of the automobile dealership.

10. The computerized system of claim 8, wherein the memory containing instructions when executed on the processor, causes the processor to perform operations that:
when the vehicle enters the service lane of the automobile dealership:
communicatively couple with an Onboard Diagnostic (OBD) device in the vehicle, wherein the OBD device is connected to the vehicle by an employee of the automobile dealership; and
obtain the vehicle information from the OBD device.

11. The computerized system of wherein the service consultant is matched with the vehicle based on based on a service-consultant availability.

12. The computerized system of claim 8,
wherein the customer information comprises a vehicle-owner name obtained from a scan of a vehicle-owner's driver's license, and
wherein the vehicle information comprises a vehicle make, a vehicle model, and a vehicle year.

13. The computerized system of claim 8, wherein the memory containing instructions when executed'on the processor, causes the processor to perform operations that:
obtain a manufacturer's three-dimensional vehicle model that matches the vehicle information.

14. The computerized system of claim 13, wherein the memory containing instructions when executed on the processor, causes the processor to perform operations that:
obtain a set of data from a digital inspection of the vehicle to identify a damage type;
display the manufacturer's three-dimensional vehicle model; and
configure the display of the manufacturer's three-dimensional vehicle model to associate the damage type with a relevant part of the manufacturer's three-dimensional vehicle model.
